(19) United States
(12) Patent Application Publication
(10) Pub. No.: US 2024/0039305 A1
(43) Pub. Date: Feb. 1, 2024

(54) Systems and Methods for Balancing Battery Packs

(71) Applicant: NXU Technologies, LLC, Tempe, AZ (US)

(72) Inventor: Kash Pantangi, Mesa, AZ (US)

(73) Assignee: NXU Technologies, LLC, Tempe, AZ (US)

(21) Appl. No.: 18/378,696

(22) Filed: Oct. 11, 2023

Related U.S. Application Data
(60) Provisional application No. 63/415,701, filed on Oct. 13, 2022.

(51) Int. Cl. H02J 7/00

(52) U.S. Cl. CPC H02J 7/0019; H02J 7/00304; H02J 7/007182; H02J 7/00714

(57) ABSTRACT

A system and method for balancing the voltages between a plurality of battery packs while charging the battery packs. A processing circuit detects the respective voltages across the battery packs and the amount of energy used by a DC load. The processing circuit configures DC-DC converters to draw energy from the battery packs to provide energy to a DC load. The processing circuit configures DC-DC converters to draw more energy from the battery pack having the higher voltage than from the other battery packs to provide the energy to the DC load. Drawing a higher amount of energy from the battery pack having the higher voltage causes the voltage difference between the battery packs to decrease until the voltages across the battery packs are about equal.

### BACKGROUND

Embodiments of the present disclosure relate to battery systems.

A battery system stores electrical energy that may be provided to an electrical device, such as an electric vehicle. A battery system may include two or more battery packs. During charging, the battery packs may charge at different rates or to different voltages. When the battery packs are connected together in parallel, the difference in voltage between the battery packs can cause large currents to flow between the battery packs possibly damaging the battery packs. Battery systems would benefit from systems and methods for balancing the respective voltage across the battery packs. Adding charging

### SUMMARY

The battery packs of a battery system receive and store electrical energy, herein referred to also simply as energy. As the battery packs receive energy, the voltage across the battery packs increases The voltage across the various battery packs may not increase at the same rate and thereby may not be the same. In an example embodiment in which the battery packs are connected in parallel after charging the batter, if there are differences in voltages across the battery packs, connecting them in parallel causes current to flow from the battery packs having a higher voltage to the battery pack having a lower voltage. The flow of current causes charge to redistribute equally between the battery packs so that the voltage across each battery pack is the about same.

However, the currents that flow between the battery packs can be so high that they damage the battery packs, the battery cells other battery packs or other circuits in the battery system. A limiting resistor may be used to limit the amount of current that flows between the battery packs; however, some of the current that flows through the limiting resistor is converted to heat which represents wasted energy. Reference A better approach, according to various aspects of the present disclosure, is to balance the charge between the battery packs prior to connecting the battery packs in parallel. According to various aspects of the present disclosure, the respective voltages across the battery packs may be balanced while the battery packs are being charged.

Balancing during charging leaves the voltage across the respective battery packs to be about the same (e.g., 0%-1.5% difference), so when the battery packs are connected in parallel, the current that flows between the battery packs is limited, so the power rating of the limiting resistor may be reduced, or the limiting resistor may possibly be eliminated altogether.

### BRIEF DESCRIPTION OF THE DRAWING

Embodiments of the present disclosure will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of an example embodiment of a battery system according to various aspects of the present disclosure.

FIG. 2 is a diagram an example embodiment of a battery pack connector block.

FIG. 3 is a diagram of the example embodiment of the battery pack connector block of FIG. 2 with the switches set to electrically couple the battery packs of FIG. 1 in series.

FIG. 4 is a diagram of the resulting electrical connections of the battery system of FIG. 1 with the battery pack connector block configured for series connection and the DC-DC converter connector block configured to drive the low-voltage rail.

FIG. 5 is a diagram of the example embodiment of the battery pack connector block of FIG. 2 with the switches set to electrically couple the battery packs of FIG. 1 in parallel.

FIG. 6 is a diagram of the resulting electrical connections of the battery system of FIG. 1 with the battery pack connector block configured for parallel connection and the DC-DC converter connector block configured to drive the low-voltage rail.

FIG. 7 is a diagram of the example embodiment of the battery pack connector block of FIG. 2 with the switches set to electrically couple the battery packs of FIG. 1 to respective DC-DC converters.

FIG. 8 is a diagram of the resulting electrical connections of the battery system of FIG. 1 with the battery pack connector block configured respective connections and the DC-DC converter connector block configured to drive the low-voltage rail.

FIG. 9 is a diagram of the battery system of FIG. 1 with the battery packs connected in parallel, the DC-DC converters configured to drive the low-voltage railing, and with a limiting resistor.

FIG. 10 is a diagram of an example embodiment of a DC-DC converter connector block.

### DETAILED DESCRIPTION

### Overview

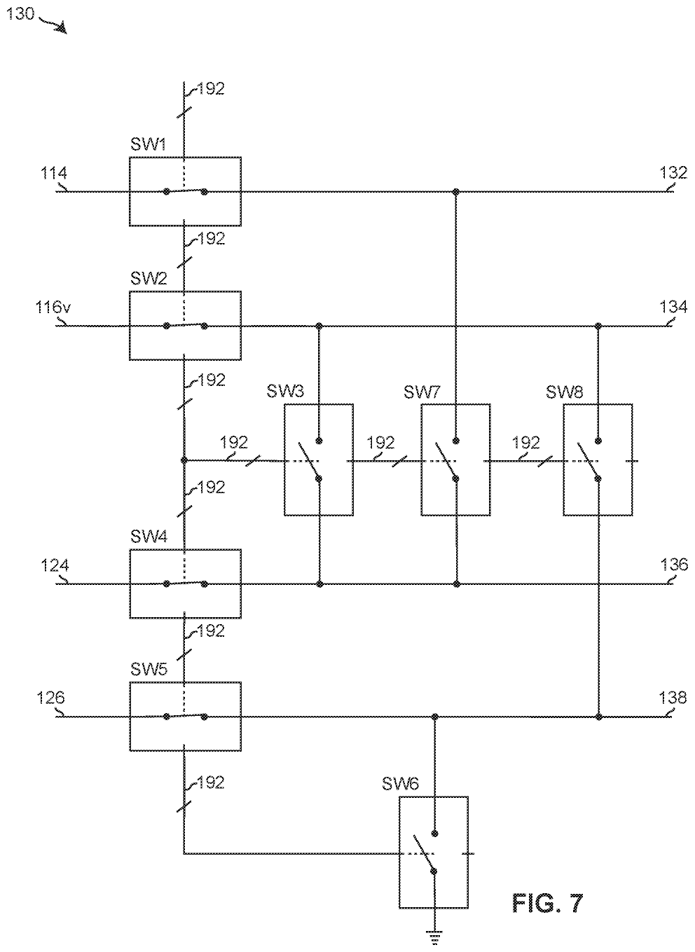

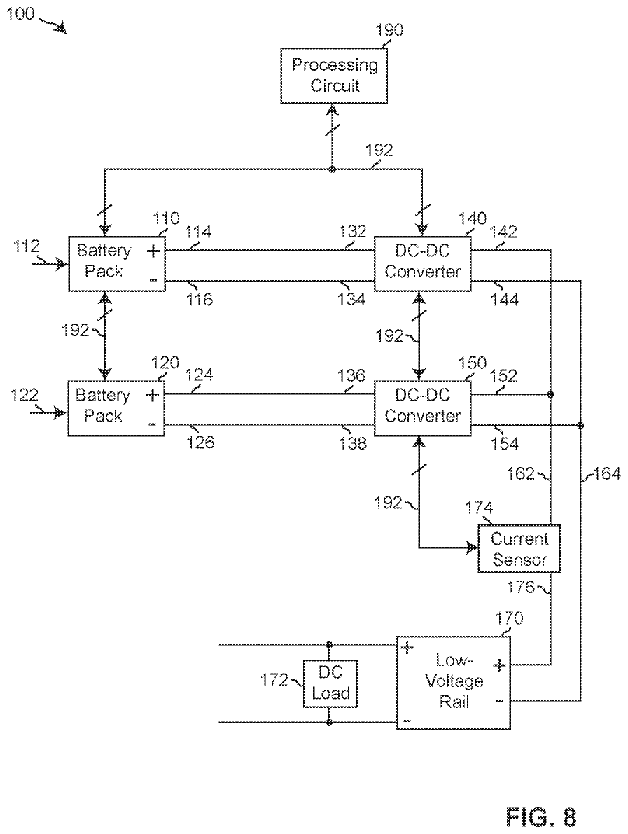

In an example embodiment, the battery system 100 performs battery pack balancing during charging. During charging, the battery pack 110 is electrically coupled (e.g., connected) to the DC-DC (e.g., DC-to-DC) converter 140 and the battery pack 120 is electrically coupled to the DC-DC converter 150, as seen in FIG. 8. The switch configuration of the battery pack connector block 130 that corresponds to the coupling of FIG. 8 is shown in FIG. 7. As the battery packs 110 and 120 charge, a difference in output voltage (e.g., voltage across 114 & 116, voltage across 124 & 126) of the battery packs 110 and 120 may develop. The processing circuit 190 is configured to monitor the output voltage of the battery packs 110 and 120. The processing circuit 190 is further configured to control the DC-DC converters 140 and 150. The DC-DC converters 140 and 150 respectively draw current (e.g., energy, power) from the battery packs 110 and 120 to provide a current (e.g., energy, power) to the DC load 172 during charging. The DC load 172 represents equipment that operates during charging. The DC load 172 may include equipment such as a battery system heater/cooler (not shown), an infotainment system (not shown), a communication system (not shown) or other system.

The processing circuit 190 is configured to control the amount of current drawn by the DC-DC converters 140 and 150 from the battery packs 110 and 120 respectively. The processing circuit 190 may configure the DC-DC converter 140 to provide a percentage (e.g., 70%, a portion) of the energy provided to the DC load 172 while the DC-DC converter 150 provides the remaining percentage (e.g., 30%). Preferably, the processing circuit 190 controls the DC-DC converters 140 and 150 so that more current (e.g., higher percentage) is drawn from the battery pack that manifests a higher output voltage. In an example embodiment, the processing circuit 190 may control the DC-DC converters 140 and 150 to draw more current from the battery pack having the higher output voltage. Drawing a higher current from the battery pack having the higher output voltage decreases the difference in the output voltage of the battery packs, until the output voltages of both battery packs are about equal.

For example, assume that during charging the voltage across the battery pack 110 (e.g., between 114 and 116) has increased to be 470 V whereas the voltage across the battery pack 120 (e.g., between 124 and 126) has increased to be 465 V. The processing circuit 190 detects the difference in voltage across the battery packs 110 and 120 and controls the DC-DC converter 140 to draw the majority (e.g., 90%) of the current consumed by DC load 172 from the battery pack 110 while the remaining amount of current (e.g., 10%) is drawn from the battery pack 120 by the DC-DC converter 150. In other words, the amount of current provided to the. DC load 172 is the sum of the currents provided by the DC-DC converters 140 and 150. Since the battery packs 110 and 120 are in the process of being charged, even though the output voltages of the battery packs may continue to rise, because more current is being drawn from the battery pack 110, the voltage difference between battery pack 110 and battery pack 120 begins to decrease. The processing circuit 190 continues to control the DC-DC converters 140 and 150 to draw unequal amounts of current until the voltages across the battery packs 110 and 120 are about the same (e.g., within 0.001%-1%).

In an example embodiment, once the voltages across the battery packs 110 and 120 are about the same, the processing circuit 190 instructs the DC-DC converters 140 and 150 to draw the same amount of current (e.g., 50% of the amount drawn by DC load 172) from the battery packs 110 and 120 respectively to maintain the voltage equal across the battery packs and to provide electrical energy consumed by DC load 172. The processing circuit 190 is configured to monitor the voltage across the battery packs 110 and 120 periodically or nearly continuously , during the charging process and to control the current drawn by the DC-DC converters 140 and 150 to make and maintain the voltages across the battery packs 110 and 120 to be about the same during the charging process. As a result, when charging is done, the output voltages of the battery packs 110 and 120 are about the same. So, battery packs 110 and 120 may be connected in parallel to provide energy to operate the electric device (e.g., electric vehicle) without causing a high current flow between the battery packs 110 and 120.

### Battery System

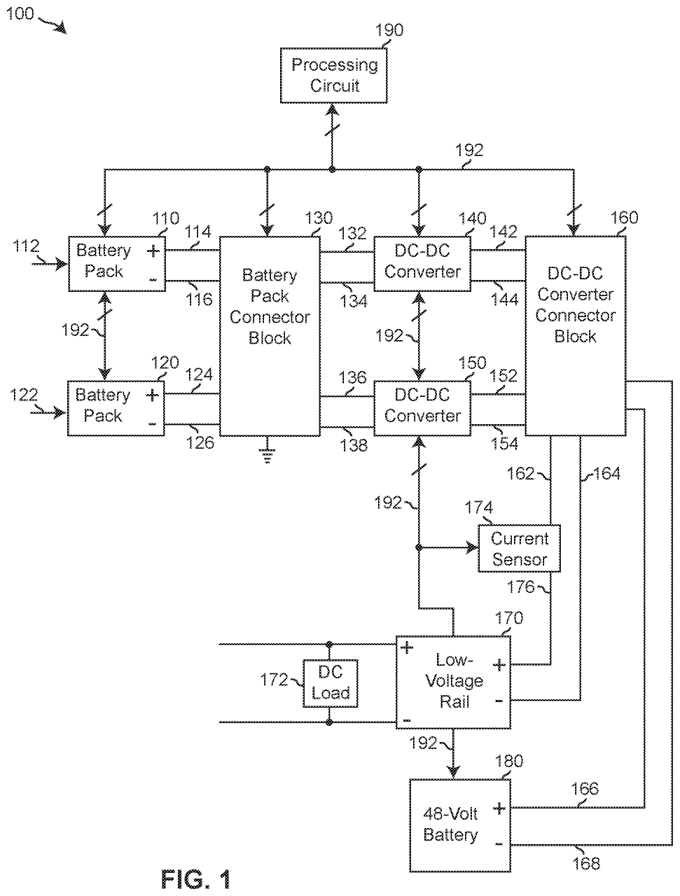

In an example embodiment, as seen in FIG. 1, the battery system 100 includes the battery pack 110, the battery pack 120, the battery pack connector block 130, the DC-DC converter 140, the DC-DC converter 150, the DC-DC converter connector block 160, the low-voltage rail 170, the 48 V battery 180, the current sensor 174 and the processing circuit 190. The battery system 100 receives electrical power (e.g., energy, current) to charge the battery packs 110 and 120 via charging input 112 and/or charging input 122. The battery system 100 provides electrical energy to a device to operate the device. In an example embodiment, the battery system 100 provides electrical energy to an electric vehicle. In an example embodiment, the battery system 100 provides a current at 474 V to the electric motors of the electric vehicle (not shown) and a current at 48 V to other systems (e.g., HVAC, lights, brakes, steering, battery system heater/cooler) of the electric vehicle (not shown).

Battery Packs, 48 V Battery and Low-Voltage rail

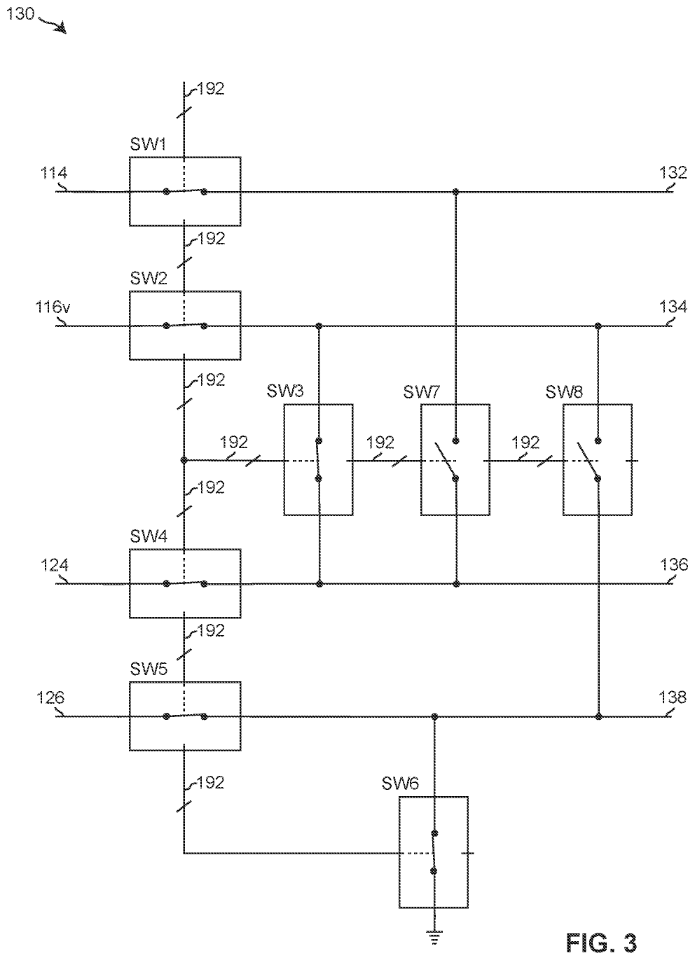

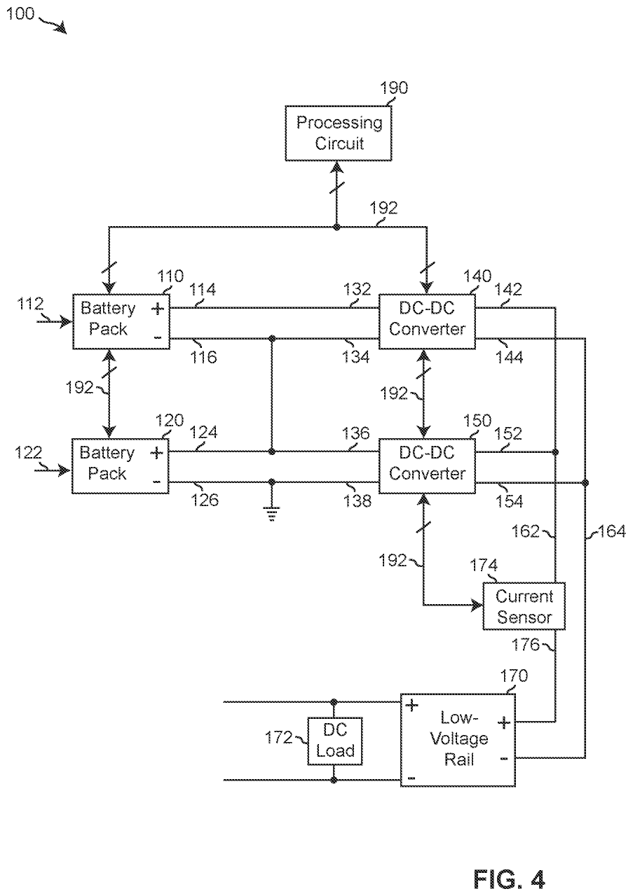

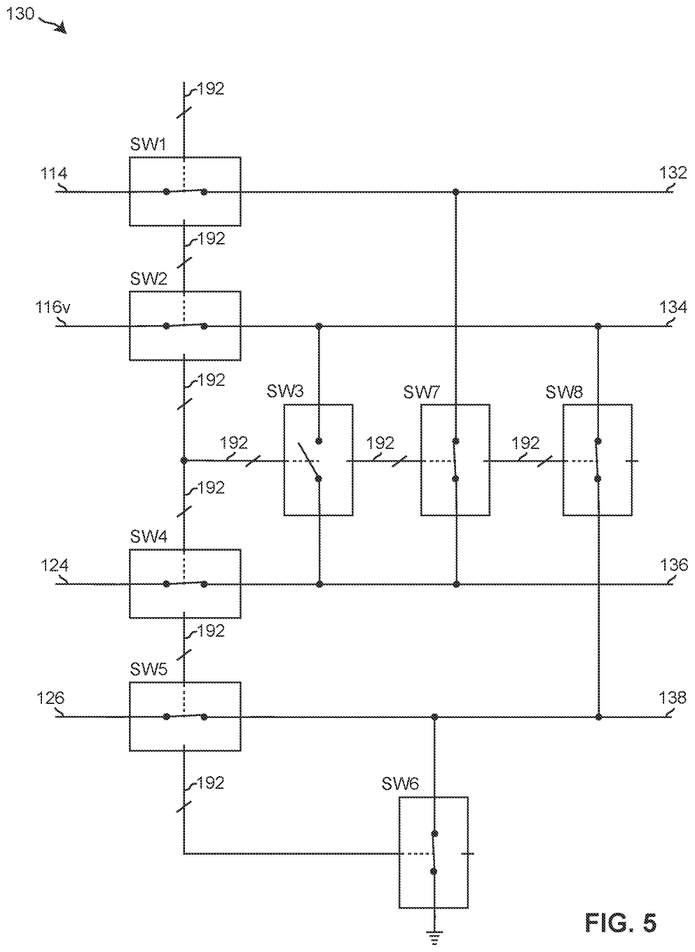

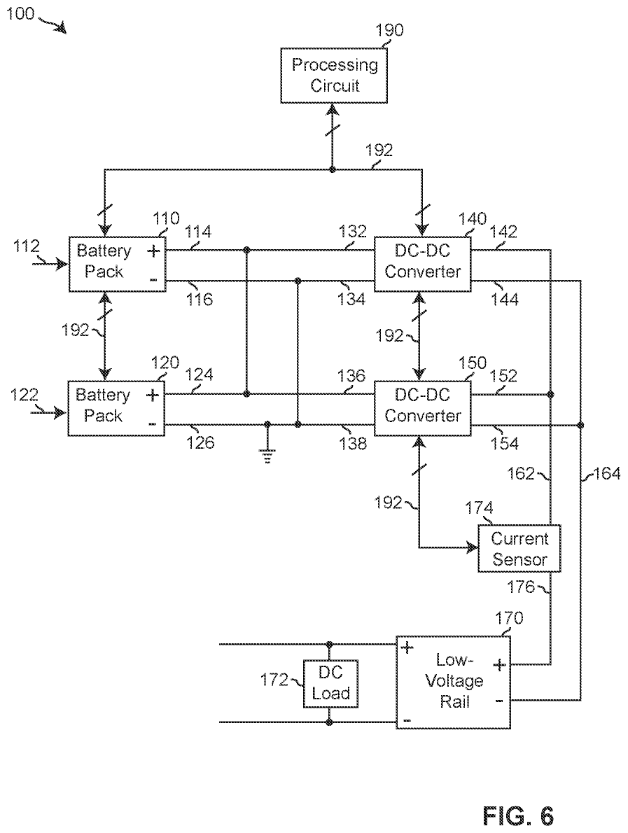

The battery packs 110 and 120 store electrical energy (e.g., power, charge). The battery packs 110 and 120, during operation, provide energy (e.g., power, charge, current). In an example embodiment, the battery packs 110 and 120 provide electric energy to an electric vehicle to operate the electric vehicle. The battery packs 110 and 120 each comprise a plurality of battery cells connected in series and/or in parallel. In an example embodiment, each battery pack 110 and 120 stores electrical energy at about the 747 V. While the output terminals of the battery packs 110 and 120 are connected in parallel, see FIG. 6 and battery pack connector block 130 switch configuration in FIG. 5, they provide electrical energy at about 747 V. While the output terminals of the battery packs 110 and 120 are connected in series, see FIG. 4 and battery pack connector block 130 switch configuration in FIG. 3, battery packs 110 and 120 provide electrical energy at around 1500 V (e.g., about 1,494 V).

The output voltage of the battery pack 110 is measured across the terminals, or in this example embodiment between connection 114 (e.g., positive terminal) and connection 116 (e.g., negative terminal). The output voltage of the battery pack 120 is measured across its terminals or in other words between connection 124 (e.g., positive terminal) and connection 126 (e.g., negative terminal). In an example embodiment, each battery pack 110 and 120 includes circuitry for measuring the voltage across its terminals and for reporting the voltage to the processing circuit 190 via the bus 192. In another example embodiment, a first voltage detector (e.g., voltmeter) is connected between connection 114 and connection 116 and a second voltage detector is connected between connection 124 and connection 126. The voltage detectors are configured to report the measure voltages to the processing circuit 190 via the bus 192.

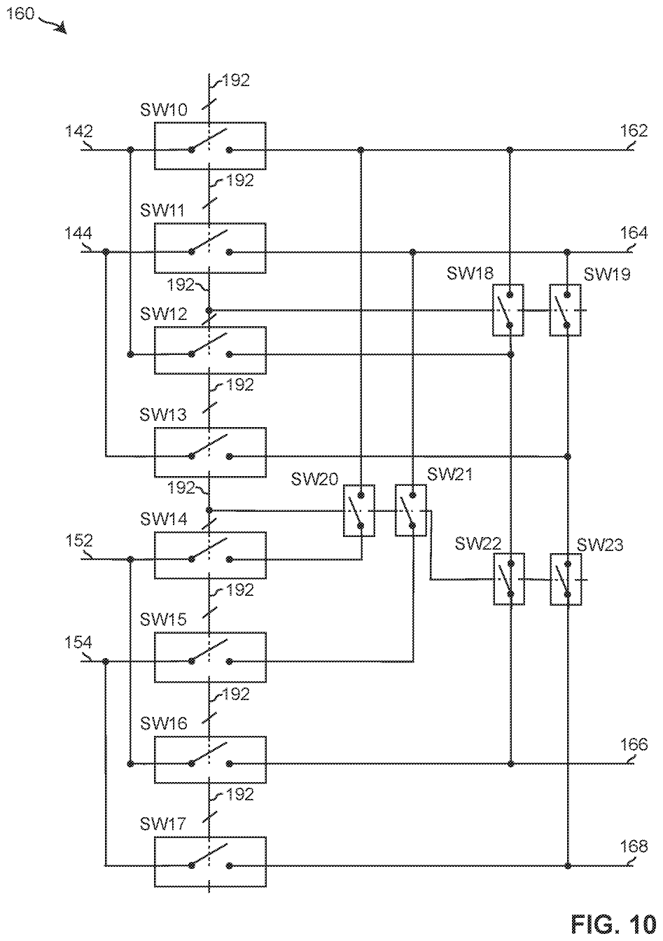

The 48 V battery 180 also stores and provides electrical energy; however, the battery 180 provides a current at 48 V. In the example embodiment described herein, the 48 V battery 180 may be charged by receiving energy from the battery packs 110 and 120 via the DC-DC converters 140 and 150. An example embodiment of the DC-DC converter connector block 160 is shown in FIG. 10. The processing circuit 190 is configured to set the switches SW10-SW19 to connect the DC-DC converters 140 or 150 to the 48 V battery 180 to provide or receive energy, to connect the DC-DC converters 140 or 150 to the low-voltage rail 170, or to connect the 48 V battery 180 to the low-voltage rail 170.

The example embodiment of the DC-DC converter connector block 160 may be configured by the processing circuit 190 so that the 48 V battery 180 can assist in balancing the voltages between the battery packs 110 and 120. For example, in a case in which the voltage on battery pack 110 is greater than the voltage on the battery pack 120 (e.g., voltage across battery pack 120 is less than the voltage across battery pack 110), the battery pack 110 provides energy to the low-voltage rail 170 to decrease the voltage across the battery pack 110. Meanwhile the 48 V battery 180 provides electrical energy to the battery pack 120 to increase the voltage across the battery pack 120. When the voltage on the battery pack 120 is greater than the voltage on the battery pack 110, the battery pack 120 may provide energy to the low-voltage rail 170 while the 48 V battery 180 provides electrical energy to the battery pack 110 thereby balancing the voltages on the battery packs 110 and 120. When the voltage across the battery pack 110 and 120 is about the same, the 48 V battery 180 is not used to provide electrical energy to either battery pack.

The low-voltage rail 170 is the rail (e.g., connection, source) the provides electrical energy to the low-voltage circuits of the device (e.g., electric vehicle) that is powered by the battery system 100. The DC load 172 represents a load of the device that is powered by the battery system 100. In an example embodiment, the battery system 100 provides energy to an electric vehicle. The electric vehicle includes systems, such as the HVAC, steering, braking, lights and the battery pack cooler/heater that use electrical energy provided at 48 V whereas the electric motors of the electric vehicle use electrical energy provided at 747 V or possibly 1494 V. The DC load 172 represents the systems that use the electrical energy at 48 V. The DC load 172 also consumes electrical energy while the battery packs 110 and 120 are being charged as discussed above.

While the battery system 100 is being used to power the device, as opposed to recharging the battery packs 110 and 120, the battery packs 110 and 120 may continue to provide energy to the low-voltage rail. During operation, the battery packs 110 and 120 are connected in series or in parallel. The series or parallel connection means the energy drawn by the DC-DC converters 140 and 150 to power the low-voltage rail 170 comes from both battery pack 110 and 120. In an example embodiment, the DC-DC converters 140 and 150 provide electrical energy to the low-voltage rail 170 at 48 V. In another example embodiment, the DC-DC converters 140 and 150 provide electrical energy to the low-voltage rail 170 at 12 V.

In another example embodiment, the process of charging the 48 V battery 180 is used to balance the voltage across the battery packs 110 and 120. In this example embodiment, energy is directed to the 48 V battery 180 to charge the 48 V battery 180. The energy used to charge the 48 V battery 180 is in addition to the energy provided to the DC load 172. If the 48 V battery 180 is fully charged before the battery packs 110 and 120 are charged, the processing circuit 190 may reconfigure the DC-DC converters connector block 160 to provide energy to the DC load 172 and not to the 48 V battery 180. As discussed above, during charging, supplying more electrical energy from one battery pack 110 or 120 than the other battery pack balances the voltages between the battery packs 110 and 120. The energy may be provided to the DC load 172 and/or the 48 V battery 180.

### Battery Pack Connector Block

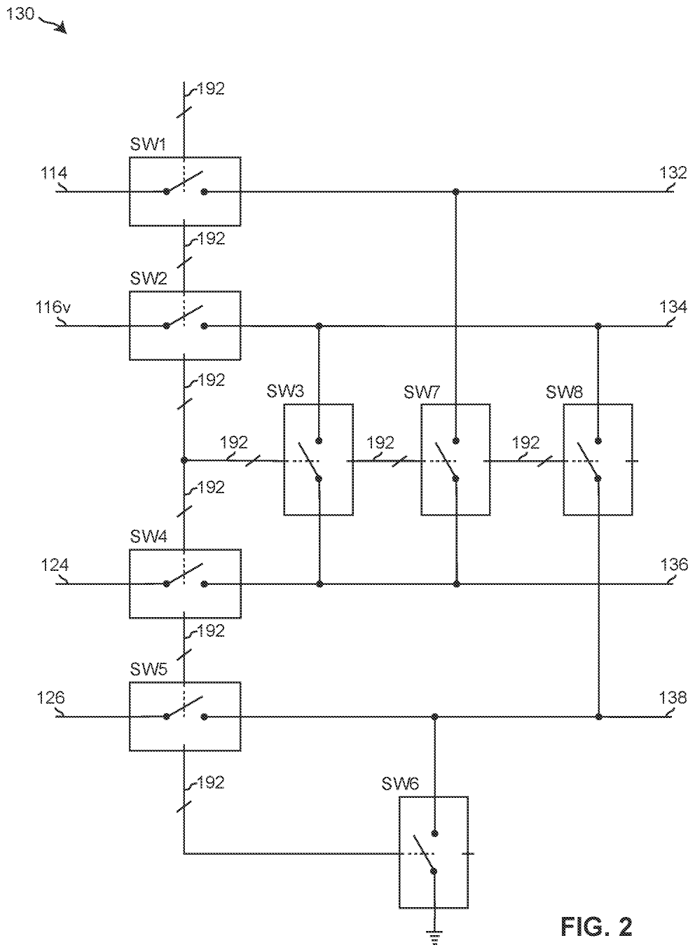

Battery pack connector block 130 may be configured to connect the output (e.g., positive, negative) terminals of battery packs 110 and 120 in series or in parallel. In an example embodiment, the connector block 160 includes a plurality of switches. The switches may be configured to connect the output terminals of the battery pack 110 and the battery pack 120 in series (see FIGS. 3-4), in parallel (see FIGS. 5-6) or to the DC-DC converters 140 and 150 respectively. In an example embodiment, as seen in FIG. 2, the battery pack connector block 130 includes switches SW1-SW8. The processing circuit 190 is configured to control (e.g., set, operate, switch) the switches of battery pack connector block 130.

While the battery system 100 is being charged, the processing circuit 190 configures the switches of the battery pack connector block 130 to connect the output terminals (e.g., 114, 116, 124, 126) of the battery packs 110 and 120 to the DC-DC converters 140 and 150 respectively as shown in FIGS. 7-8. In this example embodiment, the processing circuit 190 opens switch is SW3 and SW6-SW8 while closing the other switches SW1-SW2 and SW4-SW5.

The battery packs 110 and 120 may also be electrically coupled in series or parallel, preferably after charging, The battery packs 110 and 120 may be electrically coupled in series or parallel for charging; however, balancing by drawing a current to drive the DC load 172 cannot be accomplished because current is drawn from both battery packs 110 and 120 instead of some current from one battery pack and the remainder from the other battery pack.

### Parallel Connection

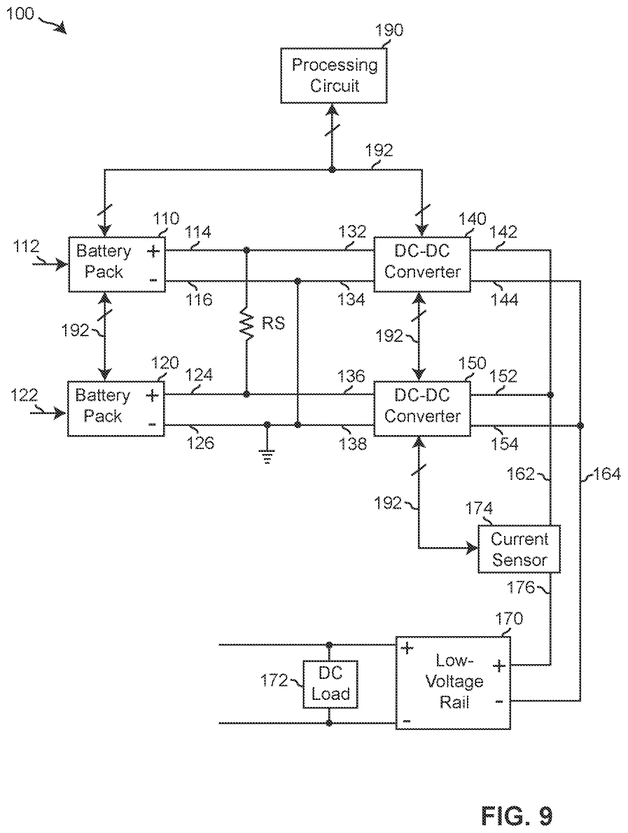

Prior to electrically coupling the battery packs 110 and 120 in parallel, as shown in FIGS. 5-6, it is preferable that the battery packs 110 and 120 be balanced (e.g., have approximately the same of output voltage). For a parallel connection, the processing circuit 190 configures the switches SW1-SW8 to connect the output terminals of the battery packs 110 and 120 in parallel. For example, to connect the output terminals of the battery packs 110 and 120 in parallel, the processing circuit 190 is configured to open switch SW3 and to close the other switches SW1-SW2 and SW4-SW8. The parallel connection of the output terminals of the battery packs 110 and 120 is shown in FIG. 6. The configuration of the switches of the battery pack connector block 130 for the parallel connection is shown in FIG. 5. The parallel connection of the output terminals of the battery packs 110 and 120 may also include a limiting resistor Rs, seen in FIG. 9, to limit the current that flows between the battery packs 110 and 120 when connected in parallel. The limiting resistor Rs limits the magnitude of the current that flows between the battery packs in the event that the battery packs 110 and 120 are not balanced prior to being connected in parallel.

If there is a difference in voltage on battery pack 110 and 120 when they are connected in parallel, a current will flow from the battery pack that has the higher voltage to the battery pack that has the lower voltage. One way to better understand the situation is with respect to charge. The battery pack that has the higher voltage generally stores more charge than the battery pack with the lower voltage. When the battery packs are connected in parallel, the charge will redistribute between the battery packs so that both battery packs hold about the same amount of charge. The parallel connection allows charge to flow from the battery pack with the higher voltage, greater amount of charge, to the battery pack with the lower voltage, lesser amount of charge.

As the current flows, the voltage on the battery pack with the higher voltage decreases, as it loses charge, while the voltage on the battery pack with the lower voltage increases, as it gains charge. The current will flow from one battery pack to the other until the voltage, or the amount of charge, of the battery packs is about the same. The battery packs are balanced when the voltages across the battery packs are about the same (e.g., ±−0.001%-1%).

The amount of current that flows between parallel-connected battery packs to balance the voltages can be high (e.g., >500 amps). A high current can damage the battery packs, so it is prudent to limit the current. The current that flows between the battery pack 110 and the battery pack 120 may be limited by placing a limiting resistor, Rs, between the battery packs, as seen in FIG. 9. The limiting resistor Rs limits the magnitude of the current that flows between the battery packs to a value that cannot damage the battery packs or the other circuits of the battery system 100. The limiting resistor Rs preferably has a power rating sufficient to handle the amount of current that flows between the battery packs 110 and 120.

If, however, the processing circuit 190 can balance the voltages on the battery packs 110 and 120 during charging, then when charging is finished and the battery packs 110 and 120 are connected in parallel, the current flow will be small or zero. The limiting resistor Rs may be used in a battery system 100 that balances the voltage on battery pack 110 and 120 during charging. However, because the battery packs are balanced prior to being connected in parallel, the power rating of the resistor Rs may be reduced because the magnitude of the current that flows between the battery packs is small. If balancing can be accomplished with sufficient accuracy, the limiting resistor Rs may be removed.

### Series Connection

For a series connection between the battery packs 110 and 120, the processing circuit 190 configures the switches SW1-SW8 of the battery pack connector block 130 to connect the output terminals of the battery packs 110 and 120 in series. For example, to connect the output terminals of the battery packs 110 and 120 in series, the processing circuit 190 is configured to close switches SW1-SW6 and to open the other switches SW7-SW8. The series connection of the output terminals of the battery packs 110 and 120 is shown in FIG. 4. The configuration of the switches of the battery pack connector block 130 for the series connection is shown in FIG. 3.

### DC-DC Converter Connector Block

The DC-DC converter connector block 160 may be configured to connect the DC-DC converters 140 and 150 to the low-voltage rail 170 or the 48 V battery 180. The DC-DC converter connector block 160 may be configured to connect the low-voltage rail 170 to the 48 V battery 180. Both the low-voltage rail 170 and the 48 V battery 180 may function as power sinks that can receive energy from the battery packs 110 and 120 via the DC-DC converters 140 and 150. As discussed above, the processing circuit 190 may determine the portion of the energy that is provided to the low-voltage rail 170 or the 48 V battery 180 by the battery pack 110 or the battery pack 120 to balance the voltages between the battery packs 110 and 120.

As briefly mentioned above, balancing may also be accomplished by providing energy from the 48 V battery 180 to one of the battery packs while the DC load 172 draws energy from the other battery pack. In the example embodiment in which the 48 V battery 180 provides energy to one of the battery packs, the corresponding DC-DC converter receives energy from the 48 V battery 180 and converts it to the voltage for providing to the battery pack to charge the battery pack. In this example embodiment, the DC-DC converters would operate as two-way converters in that they receive energy from the battery packs or provide energy to the battery packs.

The settings for the switches of the DC-DC converter connector block include settings described below. To connect the DC-DC converters 140-150 to the low-voltage rail 170, the processing circuit 190 is configured to set the switches as follows:
closed: SW10, SW11, SW14, SW15, SW20, SW21
open: SW12, SW13, SW16, SW17, SW18, SW19, SW22, SW23.

To connect the DC-DC converters 140-150 to the-48 V battery 180, the processing circuit 190 is configured to set the switches as follows:
closed: SW12, SW13, SW16, SW17, SW22, SW23.
open: SW10, SW11, SW14, SW15, SW18, SW19, SW20, SW21.

To connect the low-voltage rail 170 to the-48 V battery 180, the processing circuit 190 is configured to set the switches as follows:
closed: SW18, SW19, SW22, SW23.
open: SW10-SW17, SW20, SW21.

Various other connections between the DC-DC converters 140 and 150, the low-voltage rail 170 and the 48 V battery 180 may be made by setting the switches of the DC-DC connector block 160. Because the processing circuit 190 is configured to control the DC-DC converters, the battery pack connector block 130 and the DC-DC converter connector block 160, the processing circuit 190 may make any connection between the battery packs 110 and 120, the DC-DC converters 140 and 150, the low-voltage rail 170 and the 48 V battery 180.

### Processing Circuit

The processing circuit 190 controls the operation of the battery system 100. The processing circuit 190 may include any type of circuit, active or passive. In an example embodiment, the processing circuit 190 includes a microprocessor and any circuits (e.g., relays, voltage shifters, level shifters, amplifiers, sensors, thermocouples) to interface with, monitor and/or control the other circuits of the battery system 100. The processing circuit 190 may include a memory. The memory may store the program that is executed by the processing circuit 190 to perform the functions of controlling the battery system 100.

The processing circuit 190 communicates with the various components of the battery system 100 via the bus 192. The bus 192 may be any type of bus used with a processing circuit (e.g., microprocessors, microcontrollers, so forth): In an example embodiment, the bus 192 comprises the CAN bus. The bus 192 may include multiple signals (e.g., lines). The bus 192 may include signals for communicating (e.g., sending, receiving) addresses and/or data. The bus 192 may communicate using analog and or digital signal levels.

The processing circuit 190 is configured to control the various components of the battery system 100. The processing circuit 190 is configured to send commands (e.g., instructions) to one or more components to control the operation of the components. The processing circuit 190 is configured to receive data from the various components of the battery system 100. The processing circuit 190 may use the received data to determine how to control the various components.

### DC-DC Converters

A DC-DC, converter receives DC electrical energy and provides DC electrical energy. The DC energy received by the DC-DC converter may be at one voltage and the DC energy provided by the DC-DC converter may be at a different voltage. For example, during charging, in an example embodiment, DC-DC converter 140 or 150 receives DC energy from battery pack 110 and 120 respectively at a voltage around 474 V and provides DC energy to the low-voltage rail 170 or the 48 V battery at 48 V. The amount of energy provided by the DC-DC converter may be determined by the processing circuit 190. For example, the amount of current provided by the DC-DC converter may be increased or decreased by the processing circuit 190, thereby increasing or decreasing the amount of electrical power provided by the DC-DC converter. In an example embodiment, the processing circuit 190 controls the amount of current provided by each DC-DC converter.

In an example embodiment, during charging, the processing circuit 190 controls the amount of current provided by DC-DC converters 140 and 150 to balance the voltages on the battery packs 110 and 120 as discussed above. For example, if the voltage across the battery pack 110 is higher than the voltage across the battery pack 120, the processing circuit 190 is configured to set the DC-DC converter 140 to draw more current from the battery pack 110 than the amount of current that the DC-DC converter 150 draws from the battery pack 120. Because the DC-DC converter 140 draws more current from the battery pack 110 than the DC-DC converter 150 draws from the battery pack 120, the difference between the voltage across the battery pack 110 and the voltage across the battery pack 120 decreases, thereby balancing the voltages between the battery packs 110 and 120.

In an example embodiment, the total amount of current drawn by the DC-DC converters 140 and 150 is commensurate to the amount of energy drawn by DC load 172. The processing circuit 190 is configured to determine the amount of current drawn by the DC load 172. The processing circuit 190 is configured to determine what portion of the current drawn by the DC load 172 is provided by the DC-DC converter 140 with the remaining portion being provided by the DC-DC converter 150. The processing circuit 190 is configured to receive information from the current sensor 174. The current sensor 174 measures the current drawn by the low-voltage rail 170, and in turn by the DC load 172. The processing circuit 190 uses the information regarding the amount of current drawn by the low-voltage rail 170 to determine the amount of current to be provided by the DC-DC converters 140 and 150.

The DC-DC converters 140 and 150 may also provide energy to recharge the 48 V battery 180. The processing circuit 190 is configured to detect the voltage across the 48 V battery 180. The processing circuit may configure the DC-DC converters to provide a charging current at a voltage to the 48 V battery 180. As the 48 V battery 180 charges, the voltage across the battery 180 increases. The processing circuit 190 may detect the voltage across the 48 V battery 180 and cease charging when the processing circuit 190 detects that the 48 V battery 180 is charged. As discussed above, providing energy to charge the 48 V battery 180 may also be used to balance the voltage between the battery pack 110 and the battery pack 120.

In an example embodiment, a first voltmeter, a second voltmeter, a third voltmeter and a fourth voltmeter measure the voltage between connection 132 and connection 134, connection 136 and connection 138, connection 142 and connection 144, and connection 152 and connection 154. The voltmeters are configured to report the detected (e.g., measured) voltages to the processing circuit 190. The processing circuit 190 is configured to use the voltage information for controlling the battery system 100. In an example embodiment, a first, second, third and fourth current sensor is positioned to measure the current that flows in the connections 132, 136, 142, and 152 or connection 134, 130, 144 and 154 to detect the amount of current flowing into and out of the DC-DC converters 140 and 150. The current sensors are configured to report the measured current to the processing circuit 190, The processing circuit 190 is configured to use the information regarding measured currents to control the battery system 100.

### In Operation

In an example embodiment of how balancing is accomplished, assume that the battery system 100 is used in an electric vehicle. When the electric vehicle pulls into a charging station, the battery system 100 is informed that it will be charged. Prior to charging, the output terminals of the battery packs 110 and 120 are connected in parallel or in series to provide the electrical energy to operate the electric vehicle. During charging, the processing circuit 190 configures the battery pack connector block 130 to connect the output terminals of the battery packs 110 and 120 to the DC-DC converters 140 and 150 respectively as shown in FIGS. 7 and 8. The processing circuit 190 configures DC-DC converter connector block 160 to connect the DC-DC converter 140 and 150 to either the low-voltage rail 170 or the 48 V battery 180. In this example, as shown in FIGS. 4-8, the processing circuit 190 configures the DC-DC converter connector block 160 to connect the DC-DC converters 140 and 150 to the low-voltage rail 170 and thereby to the DC load 172.

During the process of charging the battery packs 110 and 120, the DC load 172 uses electrical energy to perform its operations. The processing circuit 190 determines the amount of current drawn by the DC load 172 via current sensor 174. Accordingly, the processing circuit 190 knows the amount of electrical energy drawn by DC load 172 to perform its operations and the amount of electrical energy for providing to the DC load 172 by the DC-DC converters 140 and 150.

The electrical energy to charge the battery packs 110 and 120 is provided via charging input 112 and charging input 122. The charging currents are provided at around 474-500 V. As the battery packs 110 and 120 are charged, the voltages across the battery packs 110 and 120 increase. Due to manufacturing tolerances and physical differences in the battery packs, the voltage on one battery pack (e.g., 110) may be higher than the voltage on the other battery pack (e.g., 120). For example, as the battery packs 110 and 120 are charged, the voltage on the battery pack 110 rises to 370 V while the voltage on battery pack 120 rises to 366 V. The processing circuit 190 detects the difference in voltage across the battery packs 110 and 120. Responsive to detecting the difference, the processing circuit 190 adjusts the current drawn by the DC-DC converters 140 and 150 from the battery packs 110 and 120 respectively to balance the voltages.

The DC-DC converters 140 and 150 provide electrical energy to DC load 172 via the low-voltage rail 170. In this example, the battery system heater/cooler operates as the DC load 172. The battery system heater/cooler maintains the temperature of the battery system 100 while charging to increase the efficiency of charging. The battery system heater/cooler consumes energy to either heat, cool or maintain the temperature of the battery packs 110 and 120. The DC-DC converters 140 and 150 provide the energy consumed by the battery system heater/cooler.

In this example, in an effort to balance (e.g., make equal, make about the same, equalize) the voltage between the battery packs 110 and 120, the processing circuit 190 configures the DC-DC converter 140 to draw 90% of the energy consumed by the battery system heater/cooler from the battery pack 110 because the output voltage across the battery pack 110 is higher than the out to voltage across the battery pack 120. The processing circuit 190 configures the DC-DC converter 150 to draw the remaining 10% of the energy drawn by the battery system heater/cooler from the battery pack 120. Assuming that the battery packs 110 and 120 continue to be charged by charging input 112 and 122 respectively, drawing more energy from the battery pack 110 than from the battery pack 120 to power the DC load 172 will cause the voltage difference between the output voltage of the battery pack 110 with respect e.g., relative) to the battery pack 120 to decrease. For example, the voltage across the battery pack 110 may rise from 370 V to 371 V in spite of the energy drawn to power the DC load 172, but the voltage across the battery pack 120 rises from 366 V to 370 V. So, the difference in voltage between the battery pack 110 and the battery pack 120 decreases from 4 V to 1 V thereby almost bringing the battery packs 110 and 120 into balance.

As the voltage of the battery pack 110 approaches the voltage of the battery pack 120, the processing circuit may change the ratio of the energy drawn by the DC-DC converters 140 and 150 from the battery packs 110 and 120 respectively. When the voltage of the battery pack 110 is about the same as the voltage on the battery pack 120, the processing circuit 190 may configure the DC-DC converters 140 and 150 to each draw 50% (e.g., half) of the energy consumed by the DC load 172 thereby maintaining about the same voltage across the battery packs 110 and 120.

The processing circuit 190 balances the voltage of the battery packs 110 and 120 during charging. When charging ends, the processing circuit 190 configures the connector block 130 to connect the output terminals of the battery packs 110 and 120 in parallel or in series to provide energy for the operation of the electric vehicle. Prior to connecting the battery packs 110 and 120 in parallel, the processing circuit 190 finishes balancing the voltage across the battery packs 110 and 120. Because balancing was performed during charging, when charging is complete, the voltage across the battery packs 110 and 120 may be balanced (e.g., about the same). If any voltage difference remains between the battery packs, the processing circuit 190 may retain the connection shown in FIGS. 7 and 8 to the DC-DC converters 140 and 150 respectively while performing further balancing. Preferably, the processing circuit 190 completes the balancing of the battery packs 110 and 120 during charging so that when charging is complete, the battery packs 110 and 120 may be immediately connected in parallel or series.

In another implementation, the processing circuit 190 balances the voltage between the battery packs 110 and 120 to be as close as possible, then when charging ends, the processing circuit 190 connects the battery packs 110 and 120 in parallel, as shown in FIGS. 5-6 and permits the remaining balancing to be accomplished by the current that flows between the battery packs 110 and 120 via the limiting resistor Rs.

When the processing circuit connects the output terminals of the battery packs 110 and 120 in parallel, the battery packs 110 and 120 provide electrical energy at about 474 V while the DC-DC converters 140 and 150 and/or the 48 V battery 180 provide electrical energy at about 48 V.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively , identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A battery system for a provided electric vehicle, the provided electric vehicle includes a provided DC load, the battery system comprising:
a first battery pack;
a second battery pack;
a first DC-DC converter, the first DC-DC converter electrically coupled to the first battery pack;
a second DC-DC converter, the second DC-DC: converter electrically coupled to the second battery pack, the first DC-DC converter and the second DC-DC converter configured to provide a first amount of energy to the provided DC load; and
a processing circuit configured to control the first DC-DC converter and the second DC-DC converter to provide the first amount of energy to the provided DC load, the processing circuit further configured to detect a first voltage across the first battery pack and a second voltage across the second battery pack; wherein while the first battery pack and the second battery pack are being charged, the processing circuit is configured to:
detect the first voltage and the second voltage;
control the first DC-DC converter to provide a majority of the first amount of energy while the first voltage is greater than the second voltage;
control the second DC-DC converter to provide a majority of the first amount of energy while the first voltage is less than the second voltage; and
control the first DC-DC converter and the second DC-DC converter to each provide about half of the first amount of energy while the first voltage is about equal to the second voltage, whereby controlling the first DC-DC converter in the second DC-DC converter to provide the first amount of energy balances the first battery pack and the second battery pack until the first voltage is about equal to the second voltage.

2. The battery system of claim 1 further comprising a first voltmeter and a second voltmeter wherein:
the first voltmeter detects the first voltage;
the second voltmeter detects the second voltage;
the first voltmeter reports the first voltage to the processing circuit; and
the second voltmeter reports the second voltage to the processing circuit.

3. The battery system of claim 1 further comprising a connector block wherein:
the connector block comprises a plurality of switches;
the processing circuit is configured to set the plurality of switches to electrically couple the first DC-DC converter to the first battery pack; and
the processing circuit is configured to set the plurality of switches to electrically couple the second DC-DC converter to the second battery pack.

4. The battery system of claim 1 further comprising a connector block wherein:
the connector block comprises a plurality of switches; and
the processing circuit is configured to set the plurality of switches to electrically couple the first DC-DC converter and the second DC-DC converter to the provided DC load to provide the first amount of energy.

5. The battery system of claim 1 further comprising a current sensor wherein:
the current sensor detects an amount of current drawn by the provided DC load;
the current sensor reports the amount of current to the processing circuit; and
the processing circuit determines the first amount of energy in accordance with the amount of current.

6. A method for balancing a first voltage across a first battery pack and a second voltage across a second battery pack while charging the first battery pack and the second battery pack, the method performed by a processing circuit, the method comprising:
detecting a first amount of energy drawn to operate a DC load, the first amount of energy provided by a first DC-DC converter and a second DC-DC converter, the first DC-DC converter electrically coupled to the first battery pack, the second DC-DC converter electrically coupled to the second battery pack, the first DC-DC converter configured to draw a second amount of energy from the first battery pack, the second DC-DC converter configured to draw a third amount of energy from the second battery pack, a sum of the second amount of energy and the third amount of energy equal to the first amount of energy;
detecting the first voltage across the first battery pack;
detecting the second voltage across the second battery pack;
while the first voltage is greater than the second voltage, controlling the first DC-DC converter and the second DC-DC converter to set the second amount of energy greater than the third amount of energy;
while the second voltage is greater than the first voltage, controlling the first DC-DC converter and the second DC-DC converter to set the third amount of energy greater than the second amount of energy; and
while the first voltage is about equal to the second voltage, controlling the first DC-DC convener and the second DC-DC converter to set the second amount of energy to be about equal to the third amount of energy; wherein:
controlling the first DC-DC converter and the second DC-DC converter to provide the first amount of energy balances the first voltage and the second voltage.

7. The method of claim 6 wherein detecting a first amount of energy comprises detecting an amount of current drawn by the DC load.

8. The method of claim 6 further comprising the processing circuit setting a plurality of switches to electrically couple the first DC-DC converter to the first battery pack.

9. The method of claim 6 further comprising the processing circuit setting a plurality of switches to electrically couple the second DC-DC converter to the second battery pack.

10. The method of claim 6 wherein detecting the first voltage comprises:
measuring the first voltage between a positive terminal and a negative terminal of the first battery pack; and
reporting the first voltage to the processing circuit.

11. The method of claim 6 wherein detecting the second voltage comprises:
measuring the second voltage between a positive terminal and a negative terminal of the second battery pack; and
reporting the second voltage to the processing circuit.

12. The method of claim 6 wherein controlling the first DC-DC converter comprises:
the processing circuit sending an instruction to the first DC-DC convener; and
the first DC-DC converter setting an output current of the first DC-DC converter in accordance with the instruction.

13. The method of claim 6 wherein controlling the second DC-DC converter comprises:
the processing circuit sending an instruction to the second DC-DC converter; and
the second DC-DC converter setting an output current of the second DC-DC converter in accordance with the instruction.

14. The method of claim 6 wherein controlling the second DC-DC converter comprises decreasing a difference between the first voltage across the first battery pack and the second voltage across the second battery pack.

15. A battery system for a provided electric vehicle, the provided electric vehicle includes a provided DC load, the battery system comprising:
a first battery pack;
a second battery pack;
a first DC-DC converter;
a second DC-DC converter;
a first connector block; and
a processing circuit configured to:
(1) control the first connector block to electrically couple the first DC-DC converter o the first battery pack and the second DC-DC converter to the second battery pack,
(2) control the first DC-DC converter and the second DC-DC converter to provide a first amount of energy to the provided DC load,
(3) detect a first voltage across the first battery pack and a second voltage across the second battery pack; wherein while the first battery pack and the second battery pack are being charged, the processing circuit is configured to:
monitor the first voltage and the second voltage;
control the first DC-DC converter to provide a majority of the first amount of energy while the first voltage is greater than the second voltage;
control the second DC-DC converter to provide a majority of the first amount of energy while the first voltage is less than the second voltage; and
control the first DC-DC converter and the second DC-DC converter to each provide about half of the first amount of energy while the first voltage is about equal to the second voltage, whereby controlling the first DC-DC converter in the second DC-DC converter to provide the first amount of energy balances the first battery pack and the second battery pack until the first voltage is about equal to the second voltage.

16. The battery system of claim 15 further comprising a first voltmeter and a second voltmeter wherein:
the first voltmeter detects the first voltage;
the second voltmeter detects the second voltage;
the first voltmeter reports the first voltage to the processing circuit; and
the second voltmeter reports the second voltage to the processing circuit.

17. The battery system of claim 15 wherein:
the first connector block comprises a plurality of switches;
the processing circuit is configured to set the plurality of switches to electrically couple the first DC-DC converter to the first battery pack; and
the processing circuit is configured to set the plurality of switches to electrically couple the second DC-DC converter to the second battery pack.

18. The battery system of claim 15 further comprising a second connector block wherein:
the second connector block comprises a plurality of switches; and
the processing circuit is configured to set the plurality of switches to electrically couple the first DC-DC converter and the second DC-DC converter to the provided DC load to provide the first amount of energy.

19. The battery system of claim 15 further comprising a current sensor wherein:
the current sensor detects an amount of current drawn by the provided DC load;
the current sensor reports the amount of current to the processing circuit; and
the processing circuit determines the first amount of energy in accordance with the amount of current.

20. The battery system of claim 15 wherein the processing circuit is further configured to control the first connector block to electrically couple the first battery pack and the second battery pack in parallel after the first battery pack and the second battery pack are charged.
